(19) United States
(12) Patent Application Publication
(10) Pub. No.: US 2026/0012883 A1
(43) Pub. Date: Jan. 8, 2026

(54) SYSTEM AND METHOD FOR NETWORK SLICING

(71) Applicant: JIO PLATFORMS LIMITED, Ahmedabad (IN)

(72) Inventors: Aayush BHATNAGAR, Navi Mumbai, Maharashtra (IN); Adityakar JHA, Gurgaon, Haryana (IN); Santosh Kumar YADAV, New Delhi (IN); Meenakshi RANI, Gurugram, Haryana (IN); Ankit MURARKA, Thane West, Maharashtra (IN); Sandeep NARULA, Navi Mumbai, Maharashtra (IN)

(73) Assignee: JIO PLATFORMS LIMITED, Ahmedabad (IN)

(21) Appl. No.: 18/992,229

(22) PCT Filed: Apr. 12, 2024
(86) PCT No.: PCT/IN2024/050385

§ 371 Date: Jan. 8, 2025

(30) Foreign Application Priority Data
Apr. 29, 2023 (IN) 202321030870

(51) Int. Cl. H04W 48/18

(52) U.S. Cl. CPC H04W 48/18

(57) ABSTRACT

The present disclosure provides system and method for network slicing at a network slice selection function (NSSF) network node, a 3GPP-defined 5G network function for selection of one of many slice instances available in an operator network, as per the user's service access request. The NSSF of a serving public land mobile network (PLMN) interfaces with access and mobility function (AMF) node of the serving PLMN and NSSF of home PLMN to service a set of functionalities including selecting a list of network slice instances serving a user equipment (UE), fetching the list of mapped network slice selection assistance information (NSSAI) for the given list of subscribed NSSAI from home NSSF of the subscriber, fetching the list of mapped NSSAI for the given list of configured NSSAI from home NSSF of the subscriber, and determining the list of AMFs to serve the UE based on tracking area wise AMF configuration.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to communication technology. In particular, the present disclosure relates to a network slice selection function (NSSF) module for network slicing.

### Definition

As used in the present disclosure, the following terms are generally intended to have the meaning as set forth below, except to the extent that the context in which they are used to indicate otherwise.

The term NSSF as used herein, refers to network slice selection function. The NSSF is a 3GPP defined 5G network function for selection of one of the many slice instances available in the operator network, as per the user's service access request.

The term PLMN as used herein, refers to public land mobile network. The PLMN is a mobile operator's cellular network in a specific country. Each PLMN has a unique PLMN code that combines a mobile country code (MCC) and the operator's mobile network code (MNC).

The term AMF as used herein, refers to access and mobility management function. The AMF is part of the 5G architecture having primary tasks including registration management, connection management, reachability management, mobility management and various function relating to security and access management and authorization.

The term NSSAI as used herein, refers to network slice selection assistance information. The NSSAI represents the set of parameters used to identify and describe a network slice.

The term SCP as used herein, refers to service communication proxy. The SCP enables dynamic scaling and management of communication and services in the 5G network.

The term NRF as used herein, refers to network repository function. The NRF works as a centralized repository for all the 5G network functions (NFs) in the operator's network.

The term NWDAF as used herein, refers to network data analytics function that is designed to streamline the way core network data is produced and consumed, as well as to generate insights and take actions to enhance end-user experience.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In fifth generation (5G) network, there are different services such as, but not limited to, massive machine type communication (mMTC), ultra-reliable low latency communication (URLLC), and enhanced mobile broadband (eMBB) services. Each of these services have specialized requirement, i.e., mMTC focuses on sensor-based Internet of Things (IoT) device connections and data transfer, URLLC focuses on the low latency with high reliability (e.g., robotics arm in hospitals), and eMBB focuses on high throughput for mobile devices, while V2X service focusses on vehicle communication.

Conventional systems and methods face difficulty in selection of suitable network slices in an optimized manner. There is, therefore, a need in the art to provide a method and a system that can overcome the shortcomings of the existing prior arts.

### OBJECTS OF THE PRESENT DISCLOSURE

Some of the objects of the present disclosure, which at least one embodiment herein satisfies are as listed herein below.

An object of the present disclosure is to provide a network slice selection function (NSSF) network node having a micro service-based architecture.

An object of the present disclosure is to support slice selection during user equipment (UE) registration based on tracking area identity (TAI)/public land mobile network (PLMN), requested network slice selection assistance information (NSSAI), and subscribed NSSAIs received from access and mobility function (AMF) node in slice selection request.

An object of the present disclosure is to support multi-PLMN/super core based NSSAI configuration.

An object of the present disclosure is to support subscriber barring, if subscriber is barred from using certain network slices.

An object of the present disclosure is to support slice barring.

An object of the present disclosure is to support integration with network data analytics function (NWDAF) for subscription/notification of slice loading, and therefore, supporting slice selection based on load factor.

An object of the present disclosure is to load balance the slice instances selection of a part slice type, static configuration, so that all the slice instances are uniformly loaded.

An object of the present disclosure is to select a suitable and optimized network slice.

An object of the present disclosure is authorization of slicing user registration.

### SUMMARY

In an exemplary embodiment, the present invention discloses a method for network slicing, the method comprising sending, by an access and mobility function (AMF), a network slice selection information request for a user equipment (UE) to a network slice selection function (NSSF). The method comprising determining, by the NSSF, an authorized network slice instance (NSI) information associated with the received network slice selection information request. The method comprising receiving, from the NSSF (104), at least one response including the determined NSI information, by the AMF. The method comprising providing at least one service to the UE based on the received at least one response.

In some embodiments, the method further comprising receiving, by the AMF, at least one error message when the NSSF fails to determine the authorized NSI information associated with the received network slice selection information request.

In some embodiments, the at least one response includes a network slice selection assistance information (NSSAI) and a list of candidate AMF required to provide the at least one service to the UE.

In some embodiments, the NSI information includes an NSI-ID and a network repository function (NRF) information.

In some embodiments, the at least one service includes a massive machine type communication (mMTC), an ultra reliable low latency communication (uRLLC) and an enhanced mobile broadband (eMBB).

In an exemplary embodiment, the present invention discloses a system for network slicing. The system comprising a first node configured to transmit a network slice selection information request for a user equipment (UE) to a second node. The second node configured to determine an authorized network slice instance (NSI) information associated with the received network slice selection information request and send at least one response including the determined NSI information to the first node.

In some embodiments, at least one service is provided to the UE based on the received at least one response.

In some embodiments, the first node comprises an access and mobility function (AMF) and the second node comprises a network slice selection function (NSSF).

In some embodiments, the first node is further configured to receive at least one error message from the second node when no authorized NSI information associated with the received network slice selection information request is determined.

In some embodiments, the at least one response includes a network slice selection assistance information (NSSAI) and a list of candidate AMF required to provide the at least one service to the UE.

In some embodiments, the NSI information includes an NSI-ID and network repository function (NRF) information.

In some embodiments, the at least one service includes a massive machine type communication (mMTC), an ultra reliable low latency communication (uRLLC) and an enhanced mobile broadband (eMBB).

In an exemplary embodiment, the present invention discloses a network slice selection function (NSSF) comprising a processor and a memory coupled to the processor, the memory containing instructions executable by the processor. The NSSF is operative to receive, from an access and mobility function (AMF), a network slice selection information request for a user equipment (UE). The NSSF is operative to determine an authorized network slice instance (NSI) information associated with the received network slice selection information request. The NSSF is operative to send at least one response including the determined NSI information to the AMF. The NSSF is operative to provide at least one service to the UE based on the received at least one response.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 illustrates an exemplary representation 100 for implementing communication between a network slice selection function (NSSF) network node with another NSSF network node in a different public land mobile network (PLMN) and with an access and mobility management function (AMF) node in the same PLMN, in accordance with embodiments of the present disclosure.

FIG. 2 illustrates an exemplary micro service-based architecture 200 of the NSSF network node, in accordance with embodiments of the present disclosure.

FIG. 3 illustrates an exemplary representation 300 of software components and architecture of the NSSF network node, in accordance with embodiments of the present disclosure.

FIG. 4 illustrates an exemplary sequence diagram 400 to retrieve network slice information during a registration process, packet data unit (PDU) session establishment, and user equipment (UE) configuration update process, in accordance with embodiments of the present disclosure.

FIG. 5 illustrates an exemplary sequence diagram 500 to update the NSSF network node with network slice selection assistance information (NSSAI), in accordance with embodiments of the present disclosure.

FIG. 6 illustrates an exemplary sequence diagram 600 to delete NSSAI availability information from the NSSF network node, in accordance with embodiments of the present disclosure.

FIG. 7 illustrates an exemplary sequence diagram 700 to subscribe to a notification of a change in a status of NSSAI, in accordance with embodiments of the present disclosure.

FIG. 8 illustrates an exemplary sequence diagram 800 to implement notify service operation at the NSSF network node, in accordance with embodiments of the present disclosure.

FIG. 9 illustrates an exemplary sequence diagram 900 to unsubscribe at the NSSF network node, in accordance with embodiments of the present disclosure.

FIG. 10 illustrates an exemplary sequence diagram 1000 to implement a registration process during roaming, in accordance with embodiments of the present disclosure.

FIG. 11 illustrates an exemplary sequence diagram 1100 to register network function (NF) profiles at a network repository function (NRF) node, in accordance with embodiments of the present disclosure.

FIG. 12 illustrates an exemplary sequence diagram 1200 to send heartbeat to the NRF node, in accordance with embodiments of the present disclosure.

FIG. 13 illustrates an exemplary computer system 1300 in which or with which embodiments of the present disclosure may be implemented.

The foregoing shall be more apparent from the following more detailed description of the disclosure.

### LIST OF REFERENCE NUMERALS

102—Access and mobility management function (AMF)
104—Network slice selection function (NSSF)
200—Micro service-based architecture
1300—A computer system
1310—External storage device
1320—Bus
1330—Main memory
1340—Read only memory
1350—Mass storage device
1360—Communication port(s)
1370—Processor

### DETAILED DESCRIPTION OF DISCLOSURE

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure relates to a third generation partnership project (3GPP) compliant, micro-service based, high capacity, scalable, and carrier-grade fifth generation (5G) network slice selection function (NSSF) cluster solution with integrated repository for storing slices and slice Instances information based on tracking area, as part of 5G core network. The NSSF network node is a 3GPP-defined 5G network function (NF) for selection of one of the many slice instances available in an operator network, as per a user's service access request. In an example embodiment, the NSSF network node of a serving public land mobile network (PLMN) interfaces with an access and mobility function (AMF) node of the serving PLMN and NSSF network node of home PLMN to service a set of functionalities. These set of functionalities may include, but not be limited to, selecting a list of network slice instances serving a user equipment (UE), fetching a list of mapped network slice selection assistance information (NSSAI) for a given list of subscribed NSSAI from home NSSF network node of a subscriber, fetching a list of mapped NSSAI for the given list of configured NSSAI from the home NSSF network node of the subscriber, and determining a list of AMFs to serve the UE based on tracking area-wise AMF configuration.

The disclosed NSSF network node provides procedures for network slice management and selection for serving 5G UEs capable of different services such as, but not limited to, massive machine type communication (mMTC), ultra-reliable low latency communication (uRLLC), and enhanced mobile broadband (eMBB) services. In an exemplary embodiment, the NSSF network node may provide a micro-service for provisioning of network slice instances for list of tracking areas and AMF-set/list. Further, the NSSF network node provides various additional functions such as, but not limited to, blanket barring of slices, barring of slices per roaming PLMN, etc.

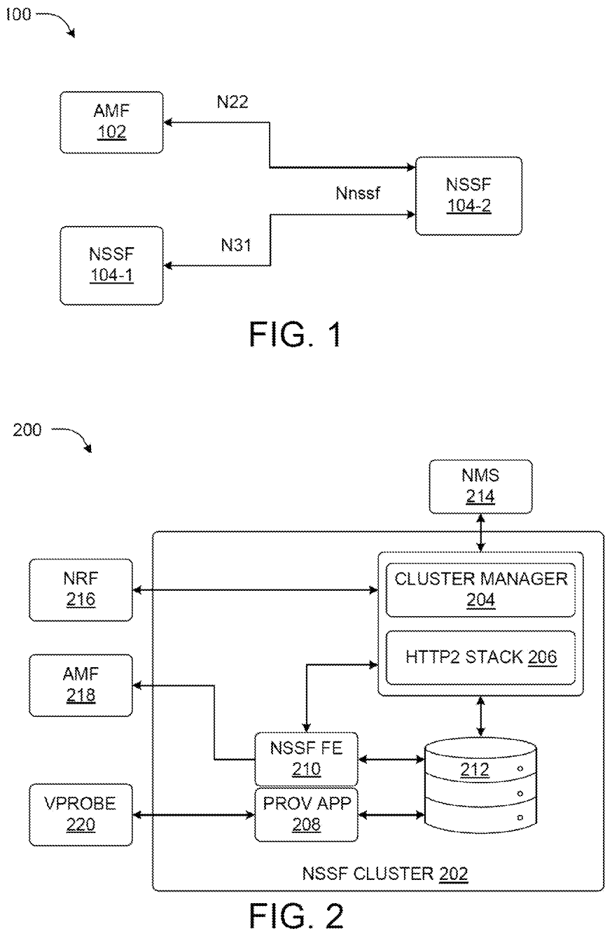

The various embodiments throughout the disclosure will be explained in more detail with reference to FIGS. 1-13.

FIG. 1 illustrates an exemplary representation 100 for implementing communication between an NSSF network node with another NSSF network node in a different PLMN, and with an AMF node of the same PLMN, in accordance with embodiments of the present disclosure.

NSSF network node is one of the key components of 5G core network. An NSSF network node (104-1, 104-2) may select different slices and service types, as per the requirements of different networks/services. In an embodiment, multiple network slice instances delivering exactly the same features for different groups of UEs may be deployed.

In 5G network, each individual end-to-end network slice has the functionality of a complete network including specific network layer capabilities, operational parameters, and network characteristics. Each individual end-to-end network slice has its own resource requirements for compute, storage, or networking. Once deployed, it is known as a “network slice instance” where each slice has at least one instance, which defines the behaviour of the slice.

Referring to FIG. 1, an NSSF network node 104-1 may offer services to an AMF 102 of same PLMN and an NSSF network node 104-2 in a different PLMN via an Nnssf service-based interface. In an embodiment, the NSSF network node 104-1 may implemented a set of functionalities including, but not limited to, authorize a set of network slice instances for AMF availability (registration), determining an allowed NSSAI for network slice selection, and determining the AMF set/candidate list to be used to serve a UE based on the AMF availability registration.

FIG. 2 illustrates an exemplary micro service-based architecture 200 of an NSSF network node, in accordance with embodiments of the present disclosure.

The disclosed architecture of the NSSF network node is an advanced architecture that ensures selection of suitable and optimized network slice (authorization of slicing-user registration) for serving UE as per the service requirement scope.

Referring to FIG. 2, the NSSF network node/cluster 202 may include a cluster manager 204, a hypertext transfer protocol 2 (HTTP2) stack 206, a provisioning gateway application 208, an NSSF front end (FE) application 210, and a slice database 212.

In an embodiment, the cluster manager 204 may provide all network repository function (NRF) 216 related functionalities on behalf of the NSSF FE application 210 and the provisioning gateway applications 208 acting as an NRF client. The cluster manager 204 supports performance counters, faults, configuration, and high availability view of different components in the NSSF network node 202. As shown in FIG. 2, the cluster manager 204 is integrated with the NRF 216 and network management station (NMS) 214 interfaces. In an embodiment, the cluster manager 204 supports 2N redundancy model. The cluster manager 204 has two components including cluster manager application 204 and HTTP2 stack 206. The cluster manager application 204 implements an HTTP interface for fault, configuration, accounting, performance, and security (FCAPS), decision of active/standby role, virtual internet protocol (IP) address (VIP) installation, and southbound communication. Further, the HTTP2 stack 206 establishes connection with peer NF. When the NSSF network node 202 subscribes to any NF from the NRF 214, notification from the NRF 214 may be received on the HTTP2 stack 206. Active cluster manager 204 selects the respective HTTP2 stack 206 for communication with the NRF 214. Therefore, the cluster manager 204 communicates with the HTTP2 stack 206 to send and receive requests towards the NRF 214.

In an embodiment, the provisioning gateway application 208 provides the application programming interface (API) support to provision the slice as per tracking area identity (TAI), single-NSSAI (SNSSAI) mapping, and restricted slice per TAI for roamers. As shown in FIG. 2, the provisioning gateway application 208 may interface with a vProbe application 220.

In an embodiment, the NSSF FE application 210 may be responsible for slice availability authorization, slice selection during initial registration, network slice instance (NSI) information during packet data unit (PDU) establishment, and availability subscription and notification. The NSSF FE application 210 may process the request based on the provisioned slice in a specific PLMN and TAI. As shown in FIG. 2, the NSSF FE application 210 may interface with an AMF 218.

Further, in an embodiment, the slice database 212 may refer to a horizontally scalable and reliable database cluster that stores configuration, slice mapping, and cluster configuration information. In an embodiment, the slice database 212 may store all static data including, but not limited to, slice information, configured NSSAI, slice mapping, etc. The slice database 212 may also store all dynamic data, e.g. AMF subscription, etc.

In an embodiment, data node cluster may refer to a set of data nodes (DNs) deployed in N-way active redundancy model. Each DN server may host two DNs. Depending on network requirements, 1+1 (Master+Slave) or 1+2 (Master+2 Slaves) local data redundancy may be configured. It may be automatically ensured that both master and slave for any data is not hosted on the same server. In an embodiment, the DNs may periodically share the information about self with all other DNs in the cluster. The information shared may include health status and partitioning information. The NSSF FE application 210, which may be aware of backend partition, ensures proper load distribution across all the DNs. Back end nodes may be added for increasing the transactional capacity of backend.

In an embodiment, in case of node failure, remaining nodes may automatically perform data migration to copy the partitions running on failed node and create new data masters to maintain the configured redundancy model. In case of node addition, the cluster manager 204 may start seamless data migration to make the new node master for some partitions and slave for other partitions.

In an embodiment, all the write requests may be first written on the master data node, and replica nodes may then be synched with the master node to ensure data consistency. Even if any data node goes down abruptly, no data is lost as there are mechanisms built in the DNs for synchronization of data to ensure hundred percent consistency of data among the replica nodes. In an embodiment, replica nodes for each partition are chosen automatically across racks for redundancy. For a pair of DNs in a data centre without geo-redundancy, both servers/blades may be placed within/across the racks depending on redundancy requirement. For geo-redundancy, a separate database cluster may be established and data across both the cluster may be replicated in asynchronous mode. Near real-time two-way Active/Active replication channel may be established with the DNs cluster on geo-redundancy site. All these DNs may be capable of automatically coming up after failures due to any software-related faults. Recovery of a DN after failure and re-synchronization of partition data is also automatic, thereby not requiring any manual action. Failure of one DN, however may not lead to service outage, as other DNs hosting data of that partition are available to service the application queries.

In an embodiment, health status and operational status of all the DNs in the cluster may be continuously monitored and all such health-related events may be reported to the cluster manager 204.

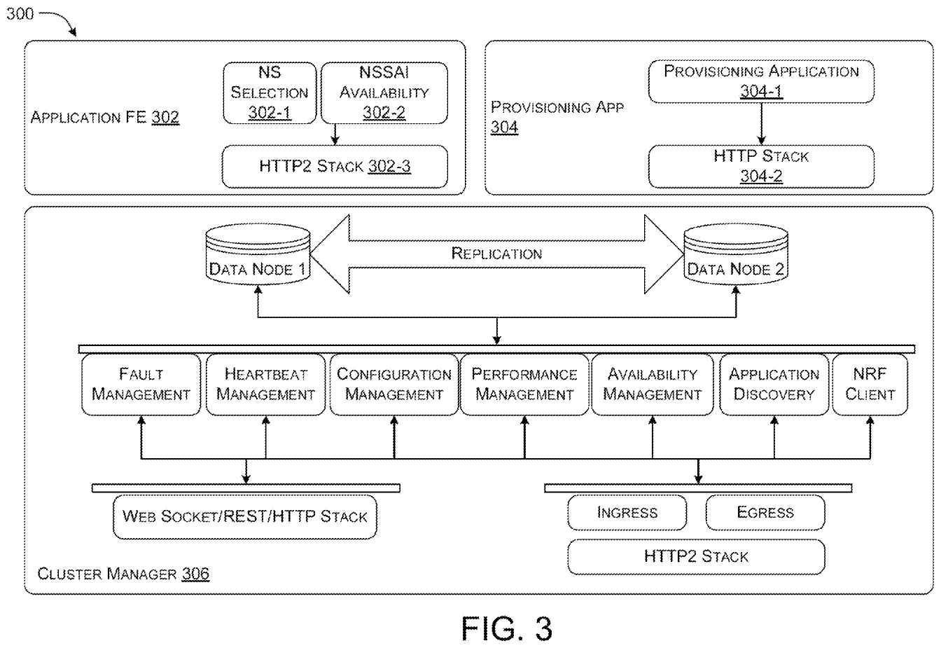

FIG. 3 illustrates an exemplary representation 300 of software components and architecture of the NSSF network node, in accordance with embodiments of the present disclosure.

Referring to FIG. 3, the NSSF network node 300 may include an application FE 302, a provisioning application 304, and a cluster manager 306. It may be appreciated that the application FE 302, the provisioning application 304, and the cluster manager 306 may be similar to the respective NSSF FE application 210, the provisioning gateway application 208, and the cluster manager 204 of FIG. 2 in their functionality. As shown in FIG. 3, the application FE 302 may include a network slice (NS) selection engine 302-1, an NSSAI availability module 302-2, and an HTTP2 stack 302-3. Further, the provisioning application 304 may include a provisioning gateway application 304-1 and an HTTP stack 304-2.

In an embodiment, the cluster manager 306 may include DNs to perform a set of functionalities, as explained herein. The set of functionalities may include, but not be limited to, fault management, heartbeat management, configuration management, performance management, availability management, application discovery, and NRF client. Each of these set of functionalities may be implemented by the respective modules of the cluster manager 306. In an embodiment, a fault management module may integrate with the NMS (e.g., 214 of FIG. 2) to provide the fault information for the specific NSSF cluster. A heartbeat management module may be responsible for sending periodic updates to the NRF (e.g., 216 of FIG. 2) for service availability of the specific NSSF cluster in a network. Further, a configuration management module may integrate with a configuration management system which helps to push configuration changes into the NSSF cluster. In an embodiment, a performance management module may integrate with a performance management system to identify key performance indicators data specific to the NSSF cluster. Further, an availability management module may be responsible to maintain high availability or redundancy among the NSSF cluster. Furthermore, an application discovery module may be responsible application discovery function for the NSSF services. In an embodiment, an NRF client module may integrate with a service communication proxy (SCP) or the NRF 216 for registration, updating, or deleting an NSSF profile. As shown in FIG. 2, the cluster manager 306 may include a web socket, representational state transfer (REST), or HTTP stack, and HTTP2 stack.

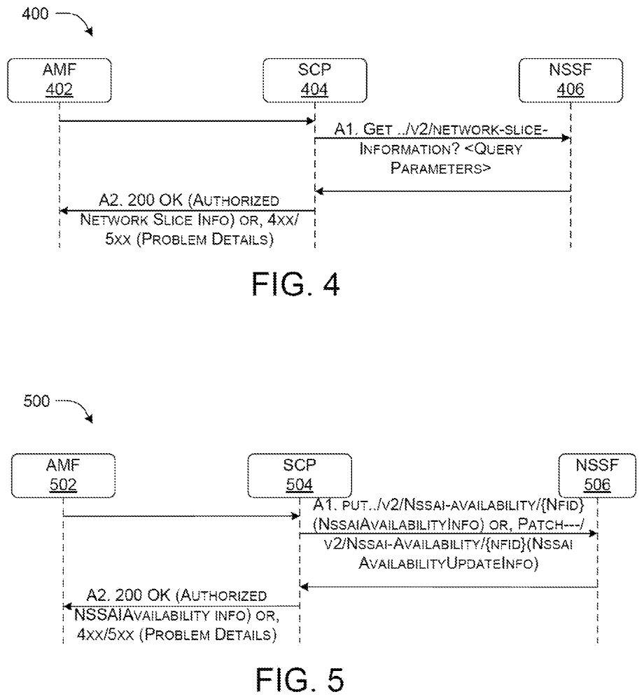

FIG. 4 illustrates an exemplary sequence diagram 400 to retrieve network slice information during a registration process, PDU session establishment, and UE configuration update process, in accordance with embodiments of the present disclosure.

In an embodiment, an AMF node 402 may retrieve the allowed NSSAI, configured NSSAI, target AMF set or the list of candidate AMF(s), and other optional information during initial registration procedure. In an aspect, the AMF node 402 may act as a first node. Referring to FIG. 4, the AMF node 402, at step A1, may send the GET request to an NSSF network node 406 via an SCP 404. In an aspect, the NSSF network node 406 may act as a second node. In an embodiment, the GET request may include query parameters such as, but not limited to, requested NSSAI, subscribed S-NSSAI(s) with an indication if marked as default S-NSSAI, PLMN identifier (ID) of the subscriber permanent identifier (SUPI), TAI, NF type of the NF service consumer, and requester ID. Based on successful processing of the GET request, the NSSF network node 406, at step A2, may send respond with “200 OK” in cases including, but not limited to, when the NSSF network node 406 is able to find authorized network slice information for the requested network slice selection information. In such a case, the response at step A2 includes at least the allowed NSSAI, target AMF set, or the list of candidate AMF(s). Further, if no slice instances may be found for the requested slice selection information, then the response at A2 may include an empty “AuthorizedNetworkSliceInfo” object. On failure scenario, the NSSF network node 406 may respond with appropriate specific HTTP error code to the AMF node 402. For international-roaming scenarios, the NSSF network node 406 may provide slice mapping between a home-PLMN (HPLMN) and visited-PLMN based on local configuration in the NSSF network node 406.

In an embodiment, the AMF node 402 may retrieve the NRF and optionally the NSI ID of the network slice instance during PDU session establishment procedure. In such an embodiment, the AMF node 402 or NSSF network node in the different PLMN, at step A1, may send a GET request to the NSSF network node 406. The request may include at least S-NSSAI, S-NSSAI from the HPLMN that maps to the S-NSSAI from the allowed NSSAI of the serving PLMN, the NF type of the NF service consumer, and requester ID. For the procedure invoked in the serving PLMN, the query parameters may also contain non-roaming/local breakout (LBO) roaming/home routed (HR) roaming indication, PLMN ID of the SUPI, and TAI. On the request being successful, the NSSF network node 406, at step A2, may respond with “200 OK” in cases including, but not limited to, when the NSSF network node 406 may be able to find network slice instance information for the requested network slice selection information, the response at step A2 may include at least the NRF to be used to select NFs/services within the selected network slice instance. Further, if no slice instances may be found for the requested slice selection information, then the response at step A2 may include an empty “AuthorizedNetworkSliceInfo” object. On failure scenario, the NSSF network node 406 may respond with appropriate specific HTTP error code to the AMF node 402.

In an embodiment, the AMF node 402 may retrieve network slice configuration information (e.g. the allowed NSSAI and the configured NSSAI) during UE configuration update procedure. In such an embodiment, the AMF node 402 from HPLMN or NSSF in the different PLMN, at step A1, may initiate a GET request to the home NSSF network node 406. The request may include query parameters such as, but not limited to, S-NSSAI, S-NSSAI from the HPLMN that maps to the S-NSSAI from the allowed NSSAI of the serving PLMN, the NF type of the NF service consumer, and requester ID. For the procedure invoked in the serving PLMN, the query parameters may also include PLMN ID of the SUPI and TAI. Once the NSSF network node 406 may be able to find network slice instance information for the requested network slice selection information, the response message at step A2 may have a payload body containing at least the NSSF network node to be used to select NFs/services within the selected network slice instance. Further, if no slice instances may be found for the requested slice selection information, then the response, at step A2, may include an empty “AuthorizedNetworkSliceInfo” object. On failure scenario, the NSSF network node 406 may respond with appropriate specific HTTP error code to the AMF node 402.

FIG. 5 illustrates an exemplary sequence diagram 500 to update the NSSF network node with NSSAI, in accordance with embodiments of the present disclosure.

In an embodiment, the AMF instance 502 may update the NSSF network node 506 with the S-NSSAIs of the NF service in the NSSF network node, and the AMF node 502 supports per TA and gets the availability of S-NSSAI. In an embodiment, it also allows to update network slice services offered by the AMF node 502. It may be appreciated that the AMF node 502, the SCP 504, and the NSSF network node 506 may be similar to the respective AMF 402, the SCP 404, and the NSSF network node 406 of FIG. 4.

Referring to FIG. 5, the AMF node 502, at step A1, may send a PUT request, via the SCP 504, to the resource representing the NSSAI availability information of the individual NF, identified by the NF ID, to replace or create the NSSAI availability information of the AMF node 502. The payload information may include the NssaiAvailabilityInfo and one or more representations of the individual supported SNSSAI information to be replaced. In another embodiment, the AMF node 502 may send a PATCH request to the resource representing the NSSAI availability information of the individual NF, identified by the NF ID, to update the NSSAI availability information of the NSSF network node 506. The payload information may include the patch document, which may include one or more patch item instructions for updating the individual supported SNSSAI resources.

At step A2, when the AMF node 502 may receive the successful response including the payload of the PUT/PATCH representation describing the status of the request and the complete AuthorizedNssaiAvailabilityData information representing the current state of the AuthorizedNssaiAvailabilityInfo.

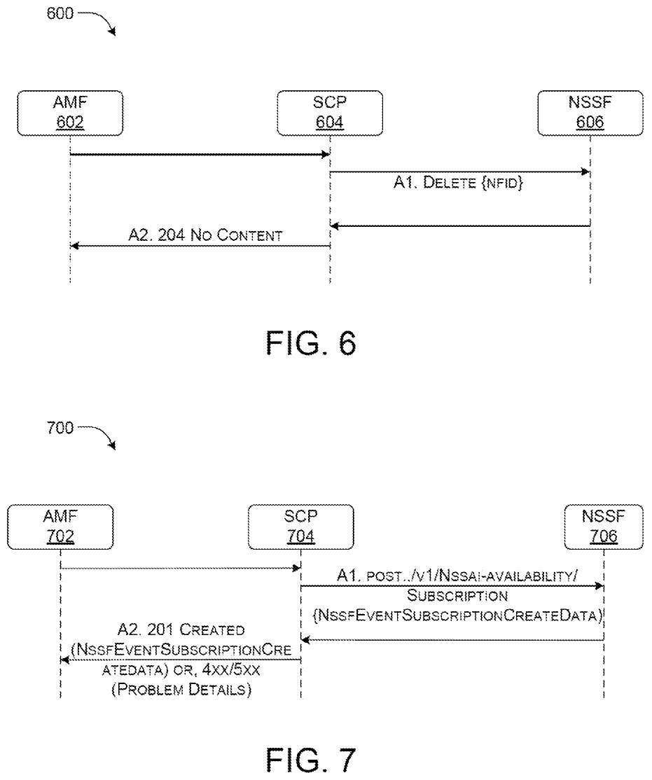

FIG. 6 illustrates an exemplary sequence diagram 600 to delete NSSAI availability information from the NSSF network node, in accordance with embodiments of the present disclosure.

In an embodiment, NSSAI availability DELETE service operation may be used by the AMF instance 602 to delete the NSSAI availability information stored for the NF service in the NSSF network node 606. It may be appreciated that the AMF 602, the SCP 604, and the NSSF network node 606 may be similar to the respective AMF 402, the SCP 404, and the NSSF network node 406 of FIG. 4.

Referring to FIG. 6, the AMF node 602, at step A1, may send, via the SCP 604, a DELETE request to remove the NSSAI availability information for the NSSF NSSAI availability service represented by the NF ID. Based on receiving the request, the NSSF network node 606 may delete the NSSAI availability information for the individual AMF node 602, and at step A2, may return with respective response status code information.

FIG. 7 illustrates an exemplary sequence diagram 700 to subscribe to a notification of a change in a status of NSSAI, in accordance with embodiments of the present disclosure.

In an embodiment, the AMF instance 702 may subscribe to a notification of any changes in status of the NSSAI availability information in S-NSSAIs available per TA and the restricted S-NSSAI(s) per PLMN in that TA in the serving PLMN of a UE. It may be appreciated that the AMF 702, the SCP 704, and the NSSF network node 706 may be similar to the respective AMF 402, the SCP 404, and the NSSF network node 406 of FIG. 4.

Referring to FIG. 7, the AMF node 702, at step A1, via the SCP 704, may send a POST request to create a subscription resource in the NSSF network node 706. The payload body of the POST request may contain a representation of the individual event subscription resource to be created in the NssfEventSubscriptionCreateData. The request may include an expiry time, suggested by the NF service consumer as a hint, representing the time up to which the subscription may be desired to be kept active, and describe the maximum duration after which the subscribed event shall stop generating report. The request may also indicate a specific AMF set to restrict the subscriptions to notifications applicable to the AMF set (i.e. notifications related to S-NSSAIs supported by the AMF set).

Once the request get success, then the AMF node 702, at step A2, may receive the event subscription from the NSSF network node 706, and the POST response may contain the representation describing the status of the created subscription in NssfEventSubscriptionCreatedData that may contain the AuthorizedNssaiAvailabilityData information, if available. The location header may include the location, i.e., uniform resource identifier (URI) of the created subscription resource.

In an embodiment, the response, based on operator policy and taking into account the expiry time included in the request, may include the expiry time, as determined by the NSSF network node 706, after which the subscription becomes invalid. Once the subscription expires, if the NF service consumer wants to keep receiving notifications, it may create a new subscription in the NSSF network node 706. The NSSF network node 706 may provide the same expiry time for many subscriptions in order to avoid all of them expiring and recreating the subscription at the same time. If the expiry time is not included in the response, then the AMF node 702 may consider the subscription to be valid without an expiry time.

In an embodiment, on failure, the NSSF network node 706 may return one of the HTTP status code together with the response to the AMF node 702.

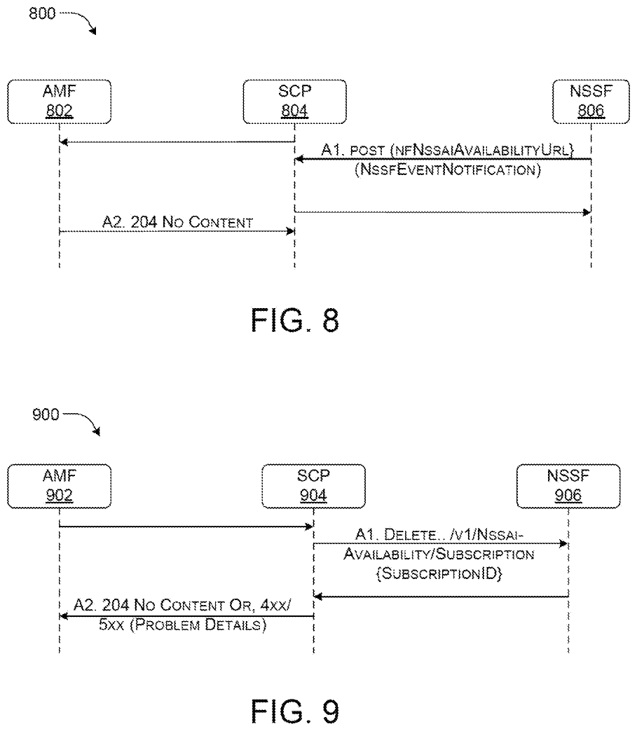

FIG. 8 illustrates an exemplary sequence diagram 800 to implement notify service operation at the NSSF network node, in accordance with embodiments of the present disclosure.

In an embodiment, the NSSF network node 806 may implement Notify Service operation, which may be used by the AMF node 802 to update the NF service with any change in status, on a per TA basis, of the S-NSSAIs available per TA (unrestricted) and the S-NSSAIs restricted per PLMN in that TA in the serving PLMN of the UE. It may be appreciated that the AMF node 802, the SCP 804, and the NSSF network node 806 may be similar to the respective AMF 402, the SCP 404, and the NSSF network node 406 of FIG. 4.

Referring to FIG. 8, the AMF node 802, at step A1, via the SCP 804, may receive, from the NSSF network node 806, a POST request to the resource representing the NSSF availability resource in the AMF node 802. The payload information of the POST request may have one representations of the individual NssfEventNotification resource. After the successful request, at step A2, the AMF node 802 may return a response to the NSSF network node 806, where the payload information of the POST response may be either no content/empty.

FIG. 9 illustrates an exemplary sequence diagram 900 to unsubscribe for NSSAI at the NSSF network node, in accordance with embodiments of the present disclosure.

In an embodiment, the AMF node 902 may unsubscribe the NSSF network node 906 and send a notification of any previously subscribed changes to the NSSAI availability information. It may be appreciated that the AMF 902, the SCP 904, and the NSSF network node 906 may be similar to the respective AMF 402, the SCP 404, and the NSSF network node 406 of FIG. 4.

Referring to FIG. 9, the AMF node 902, at step A1, via the SCP 904, may send a DELETE request to delete an existing subscription resource in the NSSF NF service. After the NF service request is accepted, the NSSF network node 906, at step A2, may respond with the status code which may indicate that the resource identified by subscription ID is successfully deleted.

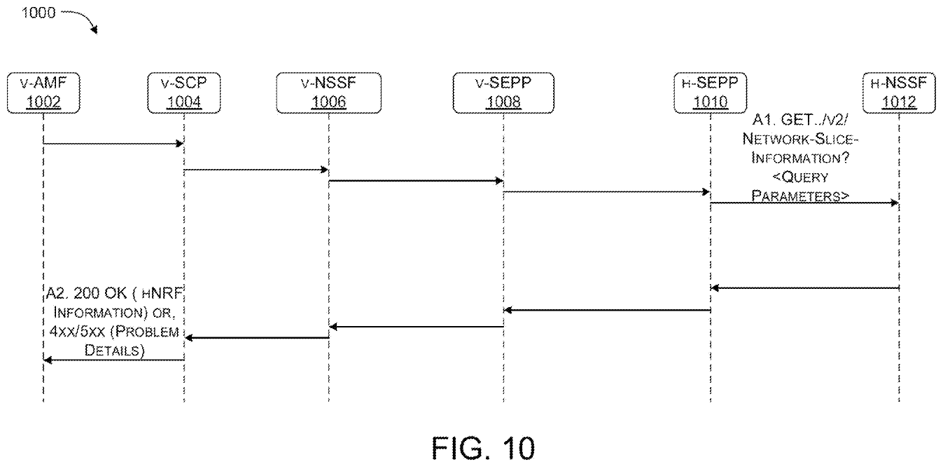

FIG. 10 illustrates an exemplary sequence diagram 1000 to implement a registration process during roaming, in accordance with embodiments of the present disclosure.

In roaming scenario, VPLMN AMF node 1002, at step A1, may send the GET request to V-NSSF node 1006 via V-SCP 1004. Based on the HPLMN, the V-NSSF node 1006 may forward the request to H-NSSF node 1012 via V-SEPP 1008 and H-SEPP 1010 using N32 interface to get the hNRF information from HPLMN. Based on the response received, at step A2, the V-NSSF node 1006 may forward the hNRF details to the VAMF node 1002 in “200 OK.” This information may be further used by the AMF node 1002 for session management function (SMF) selection.

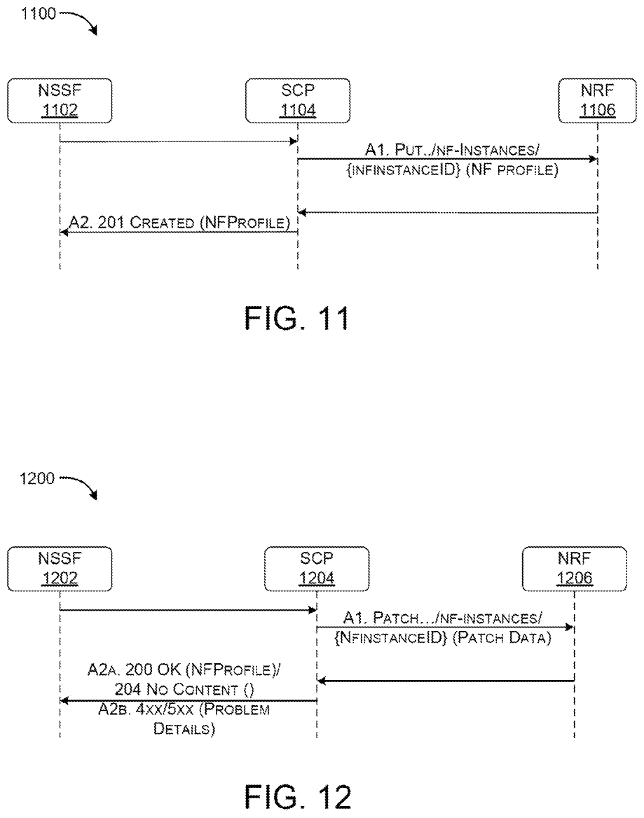

FIG. 11 illustrates an exemplary sequence diagram 1100 to register NF profiles at an NRF node, in accordance with embodiments of the present disclosure. In an embodiment, the NSSF network node 1102 may register single NF profiles for all the NSSF instances to the NRF node 1006. Referring to FIG. 11, the NSSF network node 1102, at step A1, via the SCP 1104, may send PUT request for the same to the NRF node 1106. In response, at step A2, the NRF node 1106 may send an acknowledgement to the NSSF network node 1102.

FIG. 12 illustrates an exemplary sequence diagram 1200 to send heartbeat to an NRF network node, in accordance with embodiments of the present disclosure. In an embodiment, the NSSF network node 1202 may send continuous heartbeat to the NRF node 1206 as per negotiated heartbeat time, using the NFUpdate service operation, in order to show that the NSSF network node 1202 is still operative. Referring to FIG. 12, the NSSF network node 1202, at step A1, via the SCP 1204, may send a PATCH request to the NRF node 1206. At step A2, the NSSF network node 1202 may receive an appropriate response from the NRF node 1206.

Therefore, the disclosed architecture of NSSF network node ensures selection of suitable and optimized network slice for serving UE as per the service requirement scope. The disclosed NSSF network node supports network slice selection for individual/group of requested slice(s). The NSSF network node supports slice selection based on TAI/PLMN, requested NSSAI, and subscriber NSSAI received from AMF. Further, the NSSF network node supports network slice selection for requested SNSSAI in case of PDU establishment. In such a scenario, the NSSF network node returns NSI information corresponding to SNSSAI received in PDU session request from AMF. During local breakout and non-roaming cases, the NSSF network node directly returns NSI information, while for home-routed scenarios, V-NSSF requests H-NSSF for NSI information. Furthermore, the NSSF network node stores slice mapping data of VPLMN and HPLMN slices for roaming use cases during registration procedures.

Additionally, during UE configuration update, the NF service consumer (e.g. AMF) retrieves network slice configuration information (e.g. the allowed NSSAI and the configured NSSAI). In an embodiment, the NSSF network node provides configured NSSAI based on subscribed NSSAI received from the AMF. It will be part of UE registration and UE configuration update procedures.

In an embodiment, the NSSF network node supports slice barring if subscriber is barred from using certain slice. The NSSF network node supports subscribe and notify operations. The NSSF network node creates a unique subscription ID for each AMF, and stores subscription information for notification request generation. Further, the NSSF network node may notify AMF whenever status of NSSAI changes in subscribed TAI.

In an embodiment, the NSSF network node registers with NRF when it becomes functional after application start-up process succeeds. This in turn helps other consumers to discover the NSSF network node.

In an embodiment, optimized NSSAI enables the NSSF network node to provide NSSAI availability data per list or range of TAI to AMF. Further, the SCP performs key functions that simplify the core's routing topology and offload the NRF from discovery functionality, enabling greater service-based architecture (SBA) scale. These include load balancing, message manipulation, message distribution, overload handling, traffic prioritization, and message correlation.

In an embodiment, the NSSF network node supports integration with network data analytics function (NWDAF) for subscription/notification of slice loading, and therefore, slice selection based on load factor. In an embodiment, the NSSF network node load balances the slice instances selection of a part slice type, static configuration, so that all the slice instances are uniformly loaded.

In an exemplary embodiment, the present invention discloses a method for network slicing, the method comprising sending, by an access and mobility function (AMF), a network slice selection information request for a user equipment (UE) to a network slice selection function (NSSF). The method comprising determining, by the NSSF, an authorized network slice instance (NSI) information associated with the received network slice selection information request. The method comprising receiving, from the NSSF (104), at least one response including the determined NSI information, by the AMF. The method comprising providing at least one service to the UE based on the received at least one response.

In an exemplary embodiment, the present invention discloses a system for network slicing. The system comprising a first node (AMF node) configured to transmit a network slice selection information request for a user equipment (UE) to a second node. The second node is configured to determine an authorized network slice instance (NSI) information associated with the received network slice selection information request and send at least one response including the determined NSI information to the first node.

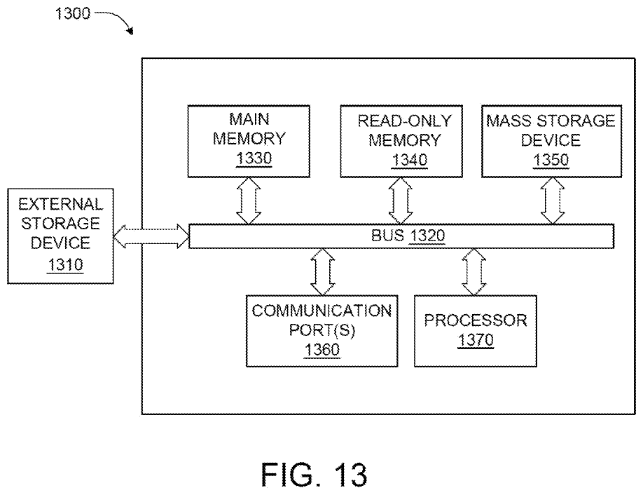

FIG. 13 illustrates an exemplary computer system 1300 in which or with which embodiments of the present disclosure may be implemented.

As shown in FIG. 13, the computer system 1300 may include an external storage device 1310, a bus 1320, a main memory 1330, a read-only memory 1340, a mass storage device 1350, communication port(s) 1360, and a processor 1370. A person skilled in the art will appreciate that the computer system 1300 may include more than one processor and communication ports. The processor 1370 may include various modules associated with embodiments of the present disclosure. The communication port(s) 1360 may be any of an RS-232 port for use with a modem-based dialup connection, a 10/100 Ethernet port, a Gigabit or 10 Gigabit port using copper or fiber, a serial port, a parallel port, or other existing or future ports. The communication port(s) 1360 may be chosen depending on a network, such a Local Area Network (LAN), Wide Area Network (WAN), or any network to which the computer system 1300 connects. The main memory 1330 may be random access memory (RAM), or any other dynamic storage device commonly known in the art. The read-only memory 1340 may be any static storage device(s) including, but not limited to, a Programmable Read Only Memory (PROM) chips for storing static information e.g., start-up or basic input/output system (BIOS) instructions for the processor 1370. The mass storage device 1350 may be any current or future mass storage solution, which may be used to store information and/or instructions.

The bus 1320 communicatively couples the processor 1370 with the other memory, storage, and communication blocks. The bus 1320 can be, e.g. a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor 1370 to the computer system 1300.

Optionally, operator and administrative interfaces, e.g. a display, keyboard, and a cursor control device, may also be coupled to the bus 1320 to support direct operator interaction with the computer system 1300. Other operator and administrative interfaces may be provided through network connections connected through the communication port(s) 1360. In no way should the aforementioned exemplary computer system 1300 limit the scope of the present disclosure.

In an aspect, the present invention discloses a network slice selection function (NSSF) comprising a processor and a memory coupled to the processor, the memory containing instructions executable by the processor. The NSSF is operative to receive, from an access and mobility function (AMF), a network slice selection information request for a user equipment (UE). The NSSF is operative to determine an authorized network slice instance (NSI) information associated with the received network slice selection information request. The NSSF is operative to send at least one response including the determined NSI information to the AMF. The NSSF is operative to provide at least one service to the UE based on the received at least one response.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

The present disclosure provides a high availability-based architecture to avoid system failure in case of a failure of any single node. The present disclosure supports load balancing as load balancers balance the slice instances selection of a part slice type, static configuration, so that all the slice instances are uniformly loaded.

The present disclosure can be implemented within a 5G architecture with various network elements that may involve various algorithms, protocols, or mechanisms to perform network slicing.

### ADVANTAGES OF THE PRESENT DISCLOSURE

The present disclosure provides micro-service based architecture of a network slice selection function (NSSF) network node.

The present disclosure provides containerized deployment of application reducing its dependency on underlying operating system distribution and version.

The present disclosure provides a high availability-based architecture to avoid system failure in case of a failure of any single node.

The present disclosure supports slice selection during user equipment (UE) registration based on tracking area identity (TAI)/public land mobile network (PLMN), requested network slice selection assistance information (NSSAI), subscribed NSSAIs received from access and mobility management function (AMF) node in slice selection request.

The present disclosure supports multi-PLMN/super core based NSSAI configuration support.

The present disclosure supports subscriber barring, i.e., if subscriber is barred from using certain network slices, NSSF network node may not return those in allowed single-NSSAIs (SNSSAIs).

The present disclosure supports slice barring, i.e., in case slice is barred, NSSF network node may not return network slice information (NSI) corresponding to barred slices.

The present disclosure supports integration with network data analytics function (NWDAF) for subscription/notification of slice loading, and therefore, slice selection based on load factor.

The present disclosure supports load balancing as load balancers balance the slice instances selection of a part slice type, static configuration, so that all the slice instances are uniformly loaded.

We claim:

1. A method for network slicing, the method comprising:
sending, by an access and mobility function (AMF) (102), a network slice selection information request for a user equipment (UE) to a network slice selection function (NSSF) (104);
determining, by the NSSF (104), an authorized network slice instance (NSI) information associated with the received network slice selection information request;
receiving, from the NSSF (104), at least one response including the determined NSI information, by the AMF (102); and
providing at least one service to the UE based on the received at least one response.

2. The method as claimed in claim 1, further comprising receiving, by the AMF (102), at least one error message when the NSSF (104) fails to determine the authorized NSI information associated with the received network slice selection information request.

3. The method as claimed in claim 1, wherein the at least one response includes a network slice selection assistance information (NSSAI) and a list of candidate AMF (102) required to provide the at least one service to the UE.

4. The method as claimed in claim 1, wherein the NSI information includes an NSI-ID and a network repository function (NRF) information.

5. The method as claimed in claim 1, wherein the at least one service includes a massive machine type communication (mMTC), an ultra reliable low latency communication (uRLLC) and an enhanced mobile broadband (eMBB).

6. A system for network slicing, the system comprising:
a first node (402) configured to:
transmit a network slice selection information request for a user equipment (UE) to a second node;
the second node (406) configured to:
determine an authorized network slice instance (NSI) information associated with the received network slice selection information request; and
send at least one response including the determined NSI information to the first node.

7. The system as claimed in claim 6, wherein at least one service is provided to the UE based on the received at least one response.

8. The system as claimed in claim 6, wherein the first node (402) comprises an access and mobility function (AMF) and the second node (406) comprises a network slice selection function (NSSF).

9. The system as claimed in claim 6, wherein the first node (402) is further configured to receive at least one error message from the second node when no authorized NSI information associated with the received network slice selection information request is determined.

10. The system as claimed in claim 6, wherein the at least one response includes a network slice selection assistance information (NSSAI) and a list of candidate AMF required to provide the at least one service to the UE.

11. The system as claimed in claim 6, wherein the NSI information includes an NSI-ID and network repository function (NRF) information.

12. The system as claimed in claim 6, wherein the at least one service includes a massive machine type communication (mMTC), an ultra reliable low latency communication (uRLLC) and an enhanced mobile broadband (eMBB).

13. A network slice selection function (NSSF) (104) comprising a processor (1370) and a memory coupled to the processor (1370), the memory containing instructions executable by the processor (1370), wherein the NSSF (104) is operative to:
receive, from an access and mobility function (AMF) (102), a network slice selection information request for a user equipment (UE);
determine an authorized network slice instance (NSI) information associated with the received network slice selection information request;
send at least one response including the determined NSI information to the AMF (102); and
provide at least one service to the UE based on the received at least one response.

14. A computer program product comprising a non-transitory computer-readable medium comprising instructions that, when executed by one or more processors, cause the one or more processors to perform a method for network slicing in a network, the method comprising:
sending, by an access and mobility function (AMF) (102), a network slice selection information request for a user equipment (UE) to a network slice selection function (NSSF) (104);
determining, by the NSSF (104), an authorized network slice instance (NSI) information associated with the received network slice selection information request;
receiving, from the NSSF (104), at least one response including the determined NSI information by the AMF (102); and
providing at least one service to the UE based on the received at least one response.
